(19) United States
(12) Patent Application Publication
(10) Pub. No.: US 2015/0046962 A1
(43) Pub. Date: Feb. 12, 2015

(54) METHOD OF CONTROLLING PHYSICALLY SEPARATED NETWORK COMPUTERS IN ONE MONITOR AND SECURITY SYSTEM USING THE SAME.

(71) Applicant: SmartQ Technologies Inc., Daejeon (KR)

(72) Inventors: GowangLo Lee, Daejeon (KR); ByoungMin Bae, Gyeonggi-do (KR)

(73) Assignee: SmartQ Technologies Inc., Daejeon (KR)

(21) Appl. No.: 13/964,666

(22) Filed: Aug. 12, 2013

(51) Int. Cl. H04N 21/41; H04N 21/431

(52) U.S. Cl. CPC H04N 21/4113; H04N 21/4312
USPC 725/110

(57) ABSTRACT

Disclosed is a method of controlling physically separated network computers in one monitor and a security system using the same in that a video information of two computers having physically separated networks is displayed on one monitor and controlled by means of a cursor, thereby reducing a video information throughput and implementing fast network switching.

### BACKGROUND OF THE INVENTION

1. Field of the Invention

The present invention relates to a method of controlling physically separated network computers in one monitor and a security system using the same. More particularly, the present invention relates to a method of controlling physically separated network computers in one monitor and a security system using the same in that a video information of two computers having physically separated networks is displayed on one monitor and controlled by means of a cursor, thereby reducing a video information throughput and implementing fast network switching.

2. Description of the Prior Art

Public institution or companies have blocked the illegal information leakage owing to an unauthorized access and have protected inside secrets and important files by means of a variety of security measures. Also, it has developed various countermeasures on the exposure of sensitive data used in the internal network during using of the external network, the internal information leakage due to hackers, the access to the internal information due to the virus, and the material damages due to the Trojan malware, the worm malware, and the backdoor malware. Accordingly, security technologies for general-purpose personal computers such as various vaccine programs, spyware detection programs, SSL (secure sockets layer) authentication uses of the web server, and server contacting management using a secure shell (SSH) of the server manager etc. are diversifying. Therefore, the public institution or the companies introduce network separation technologies of separating internal networks and external networks, so that it can prevent the internal important information from being attacked from the external networks.

Network separation and conversion technologies include a logical separation network technology for separation between an internal network area and an external network area in a single computer and a physical network separation technology using two computers.

The logical separation network technology has the merits in that it is easy to install and use, the switch of the network is fast without a reboot of the personal computer, and it is inexpensive. However, since a virtual space is utilized due to the share of the hard disk drive and a kernel process of the operating system is not completely controlled, there are defects in that it is very vulnerable to an external penetration, the security is relatively bad due to the easy invasion of the external accessor for malicious purposes, and the maintenance thereof is difficult in case of many computers.

In case of the physical network separation technique, it protects the internal network resources from the external hacking, so that the external Internet is safely supported for the use thereof, thereby providing very high security. However, there are problems in that the infrastructure construction cost is remarkably increased, the short problem of the power supply is generated in switch time between the internal and external networks, the switching between networks is time-consuming (at least 3-8 minutes), the operation efficiency thereof is deteriorated due to a discontinuous work, and it is a waste of resources such as two computers per person and two monitor per person.

Thus, it needs network separation technologies capable of having a high security, minimizing a waste of resources, and building efficient business processes.

### SUMMARY OF THE INVENTION

Accordingly, the present invention has been made to solve the above-mentioned problems occurring in the prior art, and an object of the present invention is to provide a method of controlling physically separated network computers in one monitor and a security system using the same in that file copies between physically separated network computers is prohibited, a connected computer of the user's intention is identified by a location information of a cursor, and keyboard and mouse signals are transmitted to only the connected computer to be executed, thereby rapidly conducting the operation of a network switch.

Another object of the present invention is to provide a method of controlling physically separated network computers in one monitor and a security system using the same in that video information of a plurality of computers having physically separated networks is controlled in one monitor through one keyboard and one mouse, thereby saving the construction cost of the security system and the resources.

In order to accomplish these objects, according to one embodiment of the present invention, there is provided a method of controlling physically separated network first and second computers in one monitor, comprising steps of: deciding one of the first and second computers to be connected by a user in a set-top box using a location information of a cursor appeared on the monitor; receiving a signal generated from a mouse or keyboard connected to the set-top box and transmitting the signal to the computer to be connected by the set-top box; generating video signals by operating the computer of receiving the signal of the mouse or keyboard and outputting the video signals to the set-top box; and adjusting a scaling conversion or a color space conversion of the video signals depending on whether the video signals are transmitted from a connected computer or a non-connected computer, and composing the converted video signals in the set-top box, and displaying the composed video signal on the monitor.

In order to accomplish these objects, according to another embodiment of the present invention, there is provided a set-top box of controlling physically separated network first and second computers in one monitor, comprising: a video processing module for receiving a signal generated from a mouse or a keyboard connected to the set-top box, deciding a computer to be connected by a user by grasping a location information of a cursor of the monitor screen, transmitting the signal to only the computer to be connected by the set-top box, receiving a first video signal generated by operating the first computer of receiving the signal of the mouse or the keyboard and a second video signal generated by operating the second computer of receiving the signal of mouse or the keyboard, adjusting a scaling conversion or a color space conversion on the video signals depending on whether the computer is a connected computer or a non-connected computer, and composing the converted video signals to be transmitted to the monitor; a first computer relay module for permitting an input of the first video signal and transmitting the mouse signal or the keyboard signal transmitted from the video processing module to the first computer; and a second computer relay module for permitting an input of the second video signal and transmitting the mouse signal or the keyboard signal transmitted from the video processing module to the second computer.

In order to accomplish these objects, according to further another embodiment of the present invention, there is provided a security system of controlling physically separated network first and second computers in one monitor, comprising: a first and second computers physically separated from each other through an internal and external networks and executed according to a signal received from a mouse or a keyboard; a set-top box for receiving the signal generated from the mouse or the keyboard, deciding the computer to be connected by a user from a location information of a cursor displayed on the monitor screen, transmitting the signal generated from the mouse or the keyboard to only the computer to be connected by the user, receiving a first video signal outputted from the first computer and a second video signal outputted from the second computer, adjusting a scaling conversion or a color space conversion depending on whether the computer is a connected computer or not, and composing the converted video signals to be transmitted to the monitor; the monitor connected to the set-top box; and the mouse or the key board connected to the set-top box.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block diagram illustrating a security system of controlling physically separated network computers in one monitor according to the present invention;

FIG. 2 illustrates an explanation view illustrating one example of a first window screen and a second window screen displayed on a monitor connected to a set-top box according to the present invention;

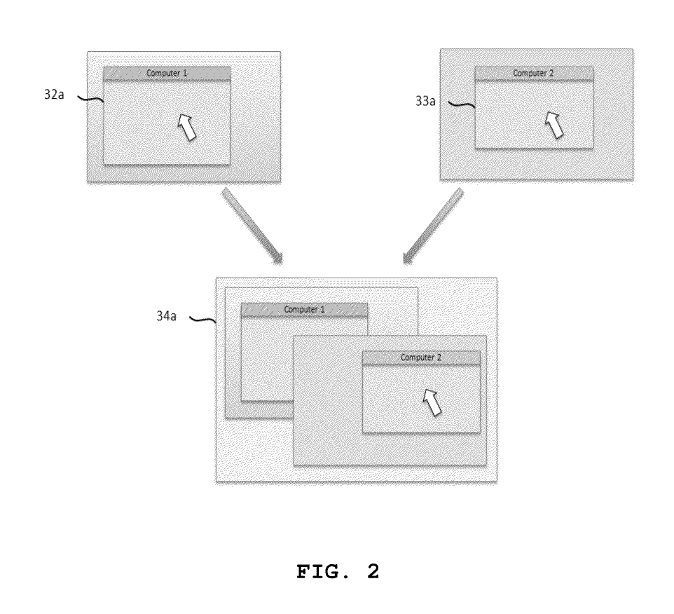

FIG. 3 illustrates an explanation view illustrating another example of a first window screen and a second window screen displayed on a monitor connected to a set-top box according to the present invention; and

FIG. 4 is a detailed block diagram illustrating a set-top box of FIG. 1 of controlling physically separated network computers in one monitor according to the present invention;

### DETAILED DESCRIPTION OF THE PREFERRED EMBODIMENTS

Hereinafter, an exemplary embodiment of the present invention will be described in detail with reference to the accompanying drawings.

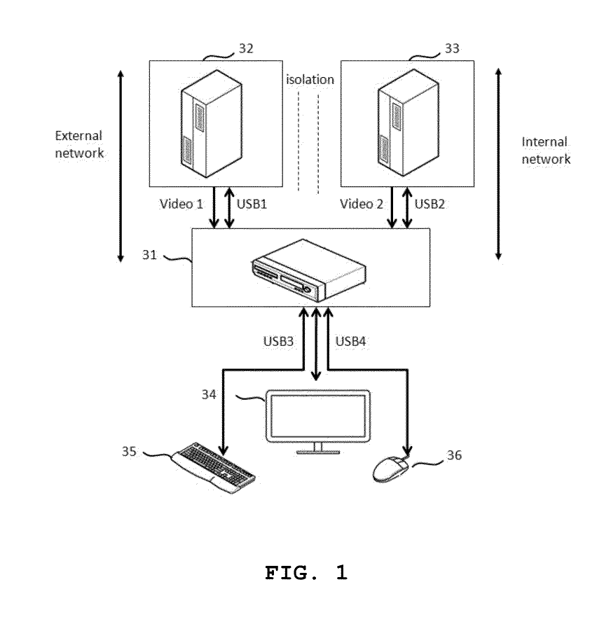

FIG. 1 is a schematic block diagram illustrating a security system of controlling physically separated network computers in one monitor according to the present invention.

As shown in FIG. 1, a security system of controlling physically separated network computers in one monitor includes a first computer 32, a second computer 33, a set-top box 31, a monitor 34, a keyboard 35, and a mouse 36.

The present invention has proposed a method of controlling a plurality of computers 32 and 33 through one monitor 34, one keyboard 35, and one mouse 36 connected to the set-top box 31 by means of a user without sharing data between the physically separated network computers.

Particularly, in the present invention, one communication channel for controlling the keyboard and the mouse is an input channel for inputting to the computers 32 and 33 from the set-top box 31 and another communication channel for transmitting only the video information of the computer is an output channel for outputting to the set-top box 31 from the computers 32 and 33. Therefore, the copy or the paste of the file between the physically separated network computers can be perfectly blocked.

The first computer 32 is connected to the set-top box 31 through a video channel (Video 1) and an USB channel (USB1). A first video signal, which is outputted from the first computer 32 through the video channel (Video 1), is transmitted to the set-top box 31. However, a video signal is not transmitted to the first computer 32 from the set-top box 31. The first computer 32 receives the mouse signal and the keyboard signal from the set-top box 31 and then executes the correspondence order, thereby generating the first video signal.

The second computer 33 is connected to the set-top box 31 through a video channel (Video 2) and an USB channel (USB2). A second video signal, which is outputted from the second computer 33 through the video channel (Video 2), is transmitted to the set-top box 31. However, a video signal is not transmitted to the second computer 33 from the set-top box 31. The second computer 33 receives the mouse signal and the keyboard signal from the set-top box 31 and then executes the correspondence order, thereby generating the second video signal.

The first computer 32 and the second computer 33 have different connection networks respectively. For example, if the first computer is connected to an external Internet, the second computer 33 is connected to an internal intranet. In other words, the first computer 32 and the second computer 33 are partial elements of the separated network security system.

The mouse 36, the keyboard 35 and the monitor 34 are connected to the set-top box 31. However, they are not directly connected to the first computer 32 or the second computer 33.

The set-top box 31 serves to allow the video signals provided from each computer 32 and 33 to be displayed on the monitor at the same time.

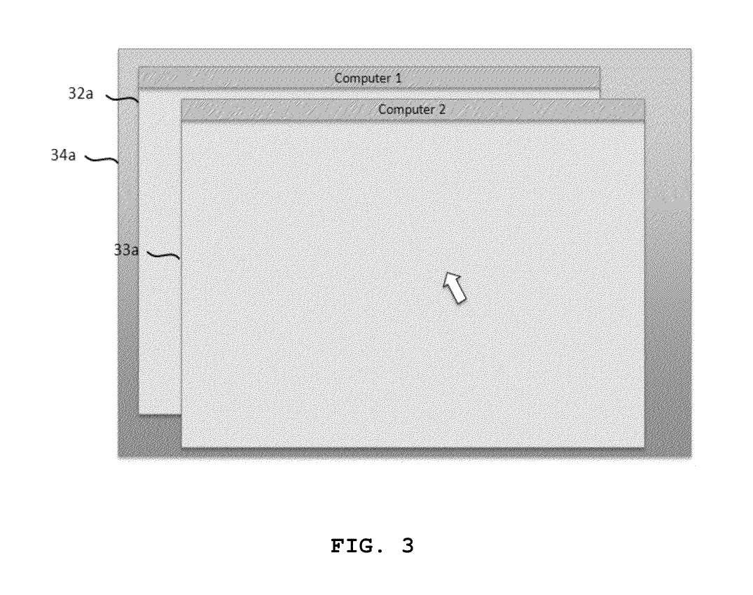

The set-top box 31 serves to control a data flow between each computer 32 and 33 and the keyboard 35 and a data flow between each computer 32 and 33 and the mouse 36. Also, referring to FIG. 3, when the window screen of the disconnected computer is overlapped with the window screen of the connected computer, the set-top box 31 does not process the video information of the overlapped area among the video signals provided by the disconnected computer and selectively processes only the video information of non-overlapped area, thereby reducing the video information through.

As shown in FIG. 3, according to the present invention, the first windows screen 32a and the second windows screen 33a are displayed on the screen 34a of one monitor. The video information on the first video signal image-processed by the set-top box 31 is displayed on the first windows screen 32a. Also, the video information on the second video signal image-processed by the set-top box 31 is displayed on the second windows screen 33a. The entire screen 34a of the monitor is the monitor screen of the set-top box 31.

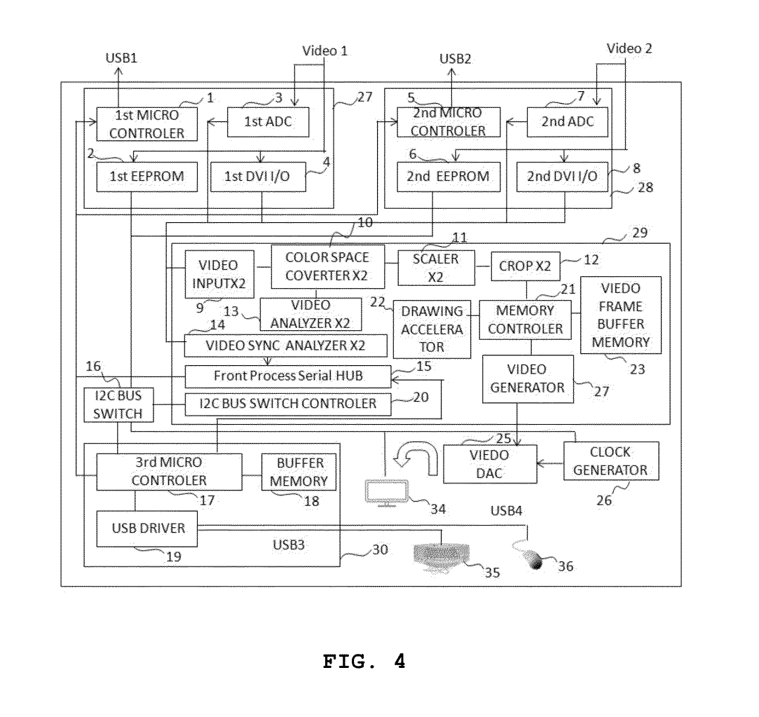

FIG. 4 is a detailed block diagram illustrating a set-top box of controlling separated network computers through one monitor according to the present invention.

The set-top box 31 includes a first computer relay module 27, a second computer relay module 28, a keyboard and mouse relay module 30, a video processing module 29, I2C bus switch 16, a video generator 24 and a video digital-to-analog converter 25.

The signal lines illustrated in FIG. 4 are I2C (inter-integrated circuit) bus line.

The first computer relay module 27 serves to permit the input of the first video signal and output the mouse signal and the keyboard signal provided by the video processing module 29 to the first computer.

The first computer relay module 27 includes a first micro controller 1, a first EEPROM 2, a first analog-to-digital converter 3, and a first digital video interface 4.

The first micro controller 1 serves to receive the mouse signal and the keyboard signal outputted from a front process serial hub 15 and transmit them to the first computer 32.

The first EEPROM 2 serves to receive the monitor information among the first video signals and buffer it to be stored therein. Also, the first EEPROM 2 serves to identify the using monitor and store the monitor information therein. The monitor information stored in the first EEPROM 2 is transmitted to a third micro controller 17, if the I2C bus switch 16 is opened.

The first analog-to-digital converter 3 serves to convert continuous analog input signals into digital output signals. The first analog-to-digital converter 3 improves the performance by adjusting the parameters. For example, the first analog-to-digital converter 3 improves the resolution of the images generated from the video signal outputted from the first computer 32.

The first digital video interface 4 is an interface between the first computer 32 and the set-top box 31. That is, the first digital video interface 4 is any interface used for transmitting the digital video signals of the first computer 32 to the set-top box 31.

The first video signal is outputted to a video input unit 9 and a video sync analyzer 14 through the first digital video interface 4.

The second computer relay module 28 serves to permit the input of the second video signal and output the mouse signal and the keyboard signal provided by the video processing module 29 to the second computer.

The second computer relay module 28 includes a second micro controller 5, a second EEPROM 6, a second analog-to-digital converter 7, and a second digital video interface 8.

The second micro controller 5 serves to receive the mouse signal and the keyboard signal outputted from the front process serial hub 15 and transmit them to the second computer 33.

The second EEPROM 6 serves to receive the monitor information among the second video signals and buffer it to be stored therein. Also, the second EEPROM 6 serves to identify the using monitor 34 and store the monitor information therein. The monitor information stored in the second EEPROM 6 is transmitted to the third micro controller 17 through the I2C bus switch 16.

The second analog-to-digital converter 7 serves to convert continuous analog input signals into digital output signal. The second analog-to-digital converter 7 improves the performance by adjusting the parameters. For example, the second analog-to-digital converter 7 improves the resolution of the images generated from the second video signal.

The second digital video interface 8 is an interface between the second computer 33 and the set-top box 31. That is, the second digital video interface 8 is any interface used for transmitting the digital video signals of the second computer 33 to the set-top box 31.

The second video signal is outputted to the video input unit 9 and the video sync analyzer 14 through the second digital video interface 8.

The set-top box 31 has access privileges of the plurality of the computers 32 and 33 and transmits the mouse signal and the keyboard signal to only the connected computer. The set-top box 31 can input only the mouse signal and the keyboard signal to the computers. Therefore, since the video information cannot be inputted to each computer through the set-top box 31, the data stored in one computer cannot be transmitted to another network computer. As a result, it can improve the security thereof.

The location of the mouse 36 or the keyboard 35 connected to the set-top box 31 is displayed on the monitor screen through a cursor. Also, each computer has its own computer's cursor. However, when the cursor is existed on the window screen of a currently running computer, it is maintained in only the corresponding computer. In order to realize this function, the video processing module 29 analyzes the location information of the cursor, so that it decides the computer to be connected by the user. Moreover, the video processing module 29 generates the mouse signal and the keyboard signal capable of executing only the computer analyzed by the connected computer. Therefore, when it is not connected to a specific computer, the cursor is not displayed on the window screen of each computer and only the cursor of the set-top box 31 is displayed on the monitor screen thereof.

In order to connect to a specific computer, the user allows the cursor to be located within the window of the specific computer. The video processing module 29 grasps the location information of the cursor information illustrated on the monitor semen and generates any signal for executing the computer having the window screen, in which the cursor is located.

Therefore, in the conventional security system of KVM switch manner, it controls the switch between the computers by means of a physical switch operation. On the other hand, in the present invention, the cursor is located at the window screen within the monitor corresponding to the relevant computer, so that the switch between computers 32 and 33 is performed, thereby enhancing the user friendliness and rapidly conducting the operation of network switching.

The video processing module 29 serves to convert an absolute location of the cursor displayed on the monitor, generate relative coordinate information on the location of the cursor, and transmit it to the connected computer. Therefore, the cursor can be accurately arranged on the window screen of the connected computer. At this time, the cursor of the set-top box is invisible. Meanwhile, only the cursor of the connected computer is displayed on the window screen.

The video processing module 29 includes a video input unit 9, a color space converter 10, a scaling module 11, a crop 12, a video analyzer 13, a video sync analyzer 14, a front process serial hub 15, an I2C bus switch controller 20, a memory controller 21, a graphic accelerator 22 and a video frame buffer memory 23.

The video input unit 9 serves to receive the video signals provided from each computer.

The color space converter 10 serves to convert a color space of the output signal of the video input unit 9 into another color space signal according to the control of the video analyzer 13.

For example, the color space converter 10 converts a 24-bit RGB into a 8-bit RGB. The color space converter 10 converts the video signal inputted from the non-connected computer into any RGB signal lower than the video signal inputted from the connected computer in terms of a bit thereof. Therefore, the window screen generated by the video signal inputted from the non-connected computer can be blurredly displayed in comparison with the window screen generated by the video signal inputted from the connected computer.

The scaling module 11 serves to adjust the number of pixels per unit area in vertical and horizontal directions so as to match the video signals with the size of the window screen and the resolution thereof.

The crop 12 serve to crop the video signal of any area overlapped with the window screen of the connected computer from the video signal of the non-connected computer, thereby reducing the video information through of the set-top box.

The present invention is provided with the video input unit 9, the color space converter 10, the scaling module 11, the crop 12, the video analyzer 13, and the video sync analyzer 14 in proportion to the number of the computers. As a result, the video signals inputted from each computer can be individually processed. For example, when the set-top box controls two computers, the video processing module 29 includes the video input unit 9, the color space converter 10, the scaling module 11, the crop 12, the video analyzer 13, and the video sync analyzer 14 by two.

The I2C bus switch controller 20 serves to control the start and the end of the transmission of the mouse signal or the keyboard signal for each computer. If the I2C bus switch controller 20 turns on the I2C bus switch 16, the monitor information stored in the EEPROM 2 provided in the computer relay module 27 is transmitted to a third micro controller 17 of a keyboard and mouse relay module 30. Also, if the I2C bus switch controller 20 turns off the I2C bus switch 16, the monitor information stored in the EEPROM 6 provided in the computer relay module 28 is transmitted to the third micro controller 17 located in the set-top box 31.

The I2C bus switch controller 20 serves to control the turn-on and turn-off of the I2C bus switch 16, so that the monitor information stored in the EEPROMs 2 and 6 can be transmitted to the third micro controller 17.

The I2C bus switch 16 is turned on or off according to the I2C bus switch controller 20, so that the monitor information stored in the EEPROM 2 is transmitted to the third micro controller 17. The memory controller 21 serves to receive the video signals from the crop 12 and process the data.

The graphic accelerator 22 serves to rapidly make the graphic processing speed of the video processing module 29.

The video frame buffer memory 23 serves to store the video signals processed in the graphic accelerator and the memory controller. Preferably, the data storage speed and the data reading-out speed can be quick by using a DDR SDRAM memory having a high data transfer speed, so that the graphic processing thereof can be speeded up.

In the present invention, the mouse signal and the keyboard signal generated from the mouse 36 and the keyboard 35 in real time is transmitted to the corresponding computer through the set-top box 31, so that it receives the real-time video information. Then, the set-top box 31 conducts the color space conversion, the scaling and the compositing to be displayed on the monitor 34. Also, in the present invention, since the mouse 36 and the keyboard 35 are not directly connected to the computer but connected to the computer through the set-top box 31, it is additionally provided with the graphic accelerator 22, the memory controller 21, and the video frame buffer memory 23 so as to supplement the lowering of the speed thereof, thereby improving the speed of the video information processing.

The video digital-to-analog converter 25 serves to convert the output signal of a video generator 24 into a video analog signal by encoding the output signal as any signal suitable for the scanning mode of the monitor 34 and transmit the video analog signal to the monitor 34 by means of the I2C bus.

The clock generator serves to input a clock signal having a frequency suitable for the monitor 34 during encoding thereof to the video digital-to-analog converter 25.

The keyboard and mouse relay module 30 includes the third micro controller 17, a buffer memory 18, and an USB driver 19.

The buffer memory 18 serves to solve a data concentration phenomenon in third micro controller 17 during generation of the USB bus traffic and store the data therein so as to smoothly transfer the data.

The USB driver is an USB HC/DC (host communication device driver) and serves to receive the signals generated from the keyboard 35 and the mouse 36.

The third micro controller 17 serves to control the data transmission quantity of the mouse and keyboard signals according to the USB bus traffic. Also, the third micro controller 17 is routed to the video processing module 29 and the I2C bus switch 16, so that the mouse signal and the keyboard signal are transmitted to the first communication relay module 27 and the second communication relay module 28, which are communicated with the computers.

Also, since the mouse signal and the keyboard signal are inputted to the non-connected computer, it can be standby without executing a specific order. In addition, the non-connection does not output any video signal having information or outputs any video signal to which the information is not inputted. Therefore, while the video signal of the latest computer running is stored in the video frame buffer memory, it can be displayed on the window screen of the non-connected computer.

The method of controlling the physically separated network computers through one monitor 34 according to the present invention will be described hereinafter.

If the mouse signal generated from the mouse 36 is inputted to the USB driver 19, the third micro controller 17 controls the USB bus traffic of the inputted mouse and keyboard signals, so that they are transmitted to the video processing module 29.

If the mouse signal and the keyboard signal are transmitted to the first micro controller 1, the first micro controller 1 serves to input the mouse signal and the keyboard signal to the first computer 32. The first computer 32 receives the mouse signal and the keyboard signal to be executed, thereby generating the first video signal. Then, the first video signal is outputted to the video input unit 9 and the video sync analyzer 14.

The video analyzer 13 serves to adjust the parameters of the analog-to-digital converter, thereby improving the resolution of the images of the video signal.

The video sync analyzer 14 decides the boundary of the activated window area of the connected computer on the monitor screen thereof and decides as to whether the connected computer is the first computer 32 or the second computer according to the location of the cursor. In addition, the video sync analyzer 14 checks out the connected computer and the non-connected computer and determines the resolution and location of the digital video signal from each computer.

The front process serial hub 15 selects the first computer 32 or the second computer 33 for transmitting the mouse signal and the keyboard signal thereto and then, the mouse signal and the keyboard signal are transmitted to the micro-controller located inside the relay module of the corresponding computer.

The monitor 34 displays the window screen of the computer connected to the front surface. Where the first window screen 32a and the second windows screen 33a are overlapped with each other, the partial image of the window screen of the non-connected computer can be hidden by the window screen of the connected computer. If the video sync analyzer 14 decides the boundaries of the window screen, the crop does not process the video signal of the hidden area, but processes only the video signal of generating non-overlapped area. Accordingly, the video data information throughput can be reduced. If the video analyzer 13 decides the video signal provided from the connected computer, in the color space converter 10, the adjustment of the RGB bit of the video signal is different for the connected computer and the non-connected computer. The RGB bit on the video information of the connected computer is adjusted through the color space converter 10 and the vertical rate and the horizontal rate of the number of pixels can be adjusted according to the size of the window screen. In case of the video information of the non-connected computer, the vertical rate and the horizontal rate of the number of pixels can be adjusted through the scaling module. Here, the crop selects and processes the video information of only the visible area on the monitor screen. The video generator 24 composes the image processing signal of the first video signal and the image processing signal of the second video signal. The graphic accelerator 22 serves to rapidly make the video information processing speed. If the signal composed by the video generator 24 is outputted to the video digital-to-analog converter 25, the output of the video generator 24 is encoded by the clock having the frequency suitable for the monitor 34 and then, it is converted into the video analog signal to be transmitted to the monitor 34. Finally, as shown in FIG. 3, the monitor 34 serves to display the first window screen and the second window screen thereon.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of controlling physically separated network first and second computers in one monitor, comprising steps of:
deciding one of the first and second computers to be connected by a user in a set-top box using a location information of a cursor appeared on the monitor;
receiving a signal generated from a mouse or keyboard connected to the set-top box and transmitting the signal to the computer decided to be connected by the set-top box;
generating video signals by operating the computer of receiving the signal of the mouse or keyboard and outputting the video signals to the set-top box; and
adjusting a scaling conversion or a color space conversion of the video signals depending on whether the video signals are transmitted from a connected computer or a non-connected computer, and composing the converted video signals in the set-top box, and displaying the composed video signal on the monitor.

2. A method of controlling physically separated network first and second computers in one monitor as claimed in claim 1, wherein, in the step of deciding one of the first and second computers to be connected by the user, it decides as to whether the computer to be connected by the user is the first computer or the second computer through a window screen having the cursor of the first window, on which a video information generated by the first computer is displayed, and the second window, on which a video information generated by the second computer is displayed.

3. A method of controlling physically separated network first and second computers in one monitor as claimed in claim 1, wherein the step of composing the converted video signals in the set-top box and displaying the composed video signal on the monitor comprising steps of:
adjusting differently the color space conversion of the video signals received from each computers depending on whether the video signals are outputted from the connected computer or the non-connected computer and composing the color space-converted signals to be transmitted to the monitor by the set-top box; and
displaying a first widow screen and a second widow screen on the monitor screen in the monitor.

4. A method of controlling physically separated network first and second computers in one monitor as claimed in claim 3, wherein, in the step of composing the converted video signals in the set-top box and displaying the composed video signal on the monitor, if the video sync analyzer decides boundaries of the window screens, a crop selects only the video signals corresponding to non-overlapped images of the first widow screen and the second widow screen from the video signals provided by the non-connected computer, thereby reducing a video data information throughput.

5. A set-top box of controlling physically separated network first and second computers in one monitor, comprising:
a video processing module for receiving a signal generated from a mouse or a keyboard connected to the set-top box, deciding a computer to be connected by a user by grasping a location information of a cursor of the monitor screen, transmitting the signal to only the computer to be connected by the user, receiving a first video signal generated by operating the first computer of receiving the signal of the mouse or the keyboard and a second video signal generated by operating the second computer of receiving the signal of the mouse or the keyboard, adjusting a scaling conversion or a color space conversion on the video signals depending on whether the computer is a connected computer or a non-connected computer, and composing the converted video signals to be transmitted to the monitor;
a first computer relay module for permitting an input of the first video signal and transmitting the mouse signal or the keyboard signal transmitted from the video processing module to the first computer; and
a second computer relay module for permitting an input of the second video signal and transmitting the mouse signal or the keyboard signal transmitted from the video processing module to the second computer.

6. A set-top box of controlling physically separated network first and second computers in one monitor as claimed in claim 5 further comprising: a keyboard and mouse relay module for receiving the signal of the mouse or the keyboard and controlling a data traffic to be transmitted to the video processing module.

7. A set-top box of controlling physically separated network first and second computers in one monitor as claimed in claim 5, wherein the video processing module serves to generate the mouse signal including any value of converting an absolute coordinate information on the location of the cursor displayed on the monitor into a relative coordinate information of the window screen of the connected computer and transmit the mouse signal to only the connected computer.

8. A set-top box of controlling physically separated network first and second computers in one monitor as claimed in claim 5, wherein the video processing module comprises a video sync analyzer for identifying a window screen having the cursor from a first widow screen, on which a first video signal is displayed, and a second widow, on which a second video signal is displayed, and deciding as to whether the computer to be connected by the user is the first computer or the second computer.

9. A set-top box of controlling physically separated network first and second computers in one monitor as claimed in claim 5, wherein the video processing module comprises a front process serial hub for transmitting the signal generated from the mouse or the keyboard to any computer relay module connected to the connected computer of the first and second relay module.

10. A set-top box of controlling physically separated network first and second computers in one monitor as claimed in claim 8, wherein the video processing module comprises:
a video input unit for receiving the first video signal and the second video signal therein;
a color space converter for adjusting differently a color space conversion depending on whether the first video signal and the second video signal are provided from the connected computer or not; and
a scaling module for adjusting a vertical rate and a horizontal rate of the number of pixels according to the size of the first window screen or the second window screen and the resolution thereof.

11. A set-top box of controlling physically separated network first and second computers in one monitor as claimed in claim 10, wherein the video processing module comprises a crop for processing only the video signal of generating any screen, which is not overlapped with the window screen of the connected computer, without processing the video signal of generating the window screen of the connected computer from the widow screen of the non-connected computer, where the window screen of the connected computer and the window screen of the non-connected computer are overlapped with each other, thereby reducing the video information through.

12. A set-top box of controlling physically separated network first and second computers in one monitor as claimed in claim 6, further comprising:
an I2C bus switch controller for turning-on or turning-off an I2C (inter-integrated circuit) bus line according to the connected computer; and
an I2C bus switch selectively turned on/off by means of the control of the I2C bus switch controller and transmitting the monitor information stored in the first computer relay module or the second computer relay module to the keyboard and mouse relay module.

13. A set-top box of controlling physically separated network first and second computers in one monitor as claimed in claim 5, wherein the video processing module comprises a video analyzer for selectively controlling a color space conversion according to the video signal inputted from the connected computer or the video signal inputted from the non-connected computer.

14. A security system of controlling physically separated network first and second computers in one monitor, comprising:
first and second computers physically separated from each other through an internal and external networks and executed according to a signal received from a mouse or a keyboard;
a set-top box for receiving the signal generated from the mouse or the keyboard, deciding the computer to be connected by a user from a location information of a cursor displayed on the monitor screen, transmitting the signal generated from the mouse or the keyboard to only the computer to be connected by the user, receiving a first video signal outputted from the first computer and a second video signal outputted from the second computer, adjusting a scaling conversion or a color space conversion depending on whether the computer is a connected computer or not, and composing the converted video signals to be transmitted to the monitor;
the monitor connected to the set-top box; and
the mouse or the key board connected to the set-top box.
